(19) United States
(12) Patent Application Publication
(10) Pub. No.: US 2010/0229359 A1
(43) Pub. Date: Sep. 16, 2010

(54) Sheet metal casket with inlays

(76) Inventor: Julius J. Larry, III, Channelview, TX (US)

Correspondence Address: LUNDEEN & LUNDEEN, PLLC, 2710 Louisiana, HOUSTON, TX, 77006, US

(21) Appl. No.: 12/645,208

(22) Filed: Dec. 22, 2009

Related U.S. Application Data
(60) Provisional application No. 61/140,560, filed on Dec. 23, 2008.

(51) Int. Cl. A61G 17/007; A61G 17/00; B21D 51/30

(52) U.S. Cl. 27/3; 27/5; 27/14; 413/2

(57) ABSTRACT

A casket of wood and steel construction and method making the same. The casket has a channel formed in the steel and a plank is inlaid in the channel.

### CROSS REFERENCE TO RELATED APPLICATIONS

This application is a non-provisional of and claims the benefit of and priority to co-pending U.S. 61/140,560 filed Dec. 23, 2008, and is also related to co-pending U.S. 29/329,943 filed Dec. 23, 2008.

### BACKGROUND OF THE INVENTION

This invention relates to steel caskets made from sheet metal with inlays in the lid.

Sheet metal is used to manufacture caskets of steel, for example. Depending on the desired strength and weight, the gauge of the steel is usually 20 or 18, for example. Twenty gauge steel is thinner and lighter, and thus less costly but not as strong as 18 gauge steel. The steel caskets are decorated by painting, polishing, and affixing decorative elements with adhesives or bolts, for example.

Wood caskets are also available but tend to be heavy and expensive, depending on the wood used in the construction.

### SUMMARY OF THE INVENTION

In an embodiment, the invention provides an inlaid sheet metal, e.g. steel, casket, and a method of making an inlaid sheet metal casket. In an embodiment, the casket can also include appointments attached to a surface thereof. In an embodiment, the inlays and the appointments, if present, can be made of or surfaced with wood. In an embodiment, the inlays and/or the appointments, if present, can be both decorative to enhance the appearance of the casket as well as structural to reinforce the casket for strength.

### BRIEF DESCRIPTION OF THE DRAWINGS

FIG. 1 is a perspective view of a casket according to an embodiment.

FIG. 2 is a perspective view of the casket of FIG. 1 showing the head lid of the casket open according to an embodiment.

FIG. 3 is an end (head) elevational view of the casket of FIG. 1 according to an embodiment.

FIG. 4 is an end (foot) elevational view of the casket of FIG. 1 according to an embodiment.

FIG. 5 is a front elevational view of the casket of FIG. 1 according to an embodiment.

FIG. 6 is a top plan perspective view of the casket of FIG. 1 according to an embodiment.

FIG. 7 is an inner end perspective elevational view of the closed foot lid of the casket of FIG. 1 according to an embodiment.

FIG. 8 is a closeup view of the closed foot lid of FIG. 7.

FIG. 9 is an outer end perspective elevational view of the open foot lid of the casket of FIG. 1 according to an embodiment.

FIG. 10 is an enlarged inner end elevational view of the open head lid of the casket of FIG. 1 according to an embodiment.

FIG. 11 is an enlarged inner end perspective view of the open lids of the casket of FIG. 1.

FIG. 12 is a bottom plan perspective view of the casket of FIG. 1 according to an embodiment.

FIG. 13 is a sectional view of the foot lid of the casket of FIG. 6 as seen along the lines 13-13.

FIG. 14 is an exploded view of the foot lid of FIGS. 6 and 13 according to an embodiment.

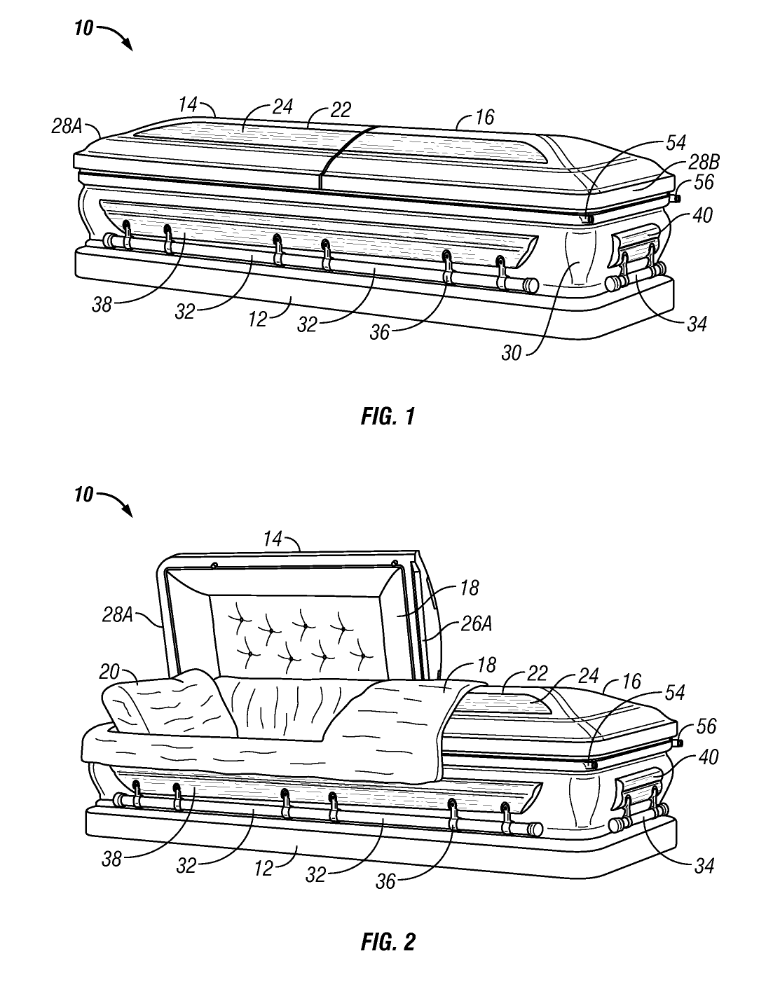

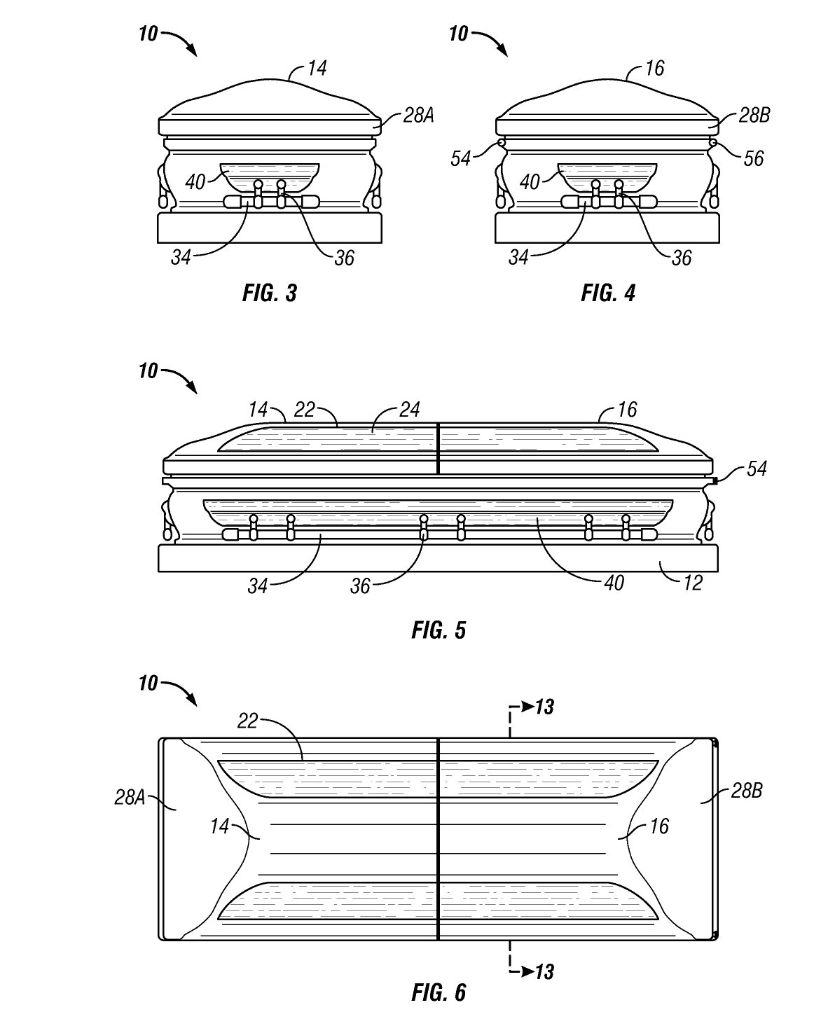

### DETAILED DESCRIPTION

According to an embodiment, the casket 10 generally comprises a box 12, a lid 14 at the head, and a lid 16 at the foot. The lids 14, 16 are hingedly secured to the box 10 at a back upper edge thereof. The box 10 and lids 14, 16 can optionally be provided with removably secured linings 18, pillow 20 and other interior appointments familiar to those in the art.

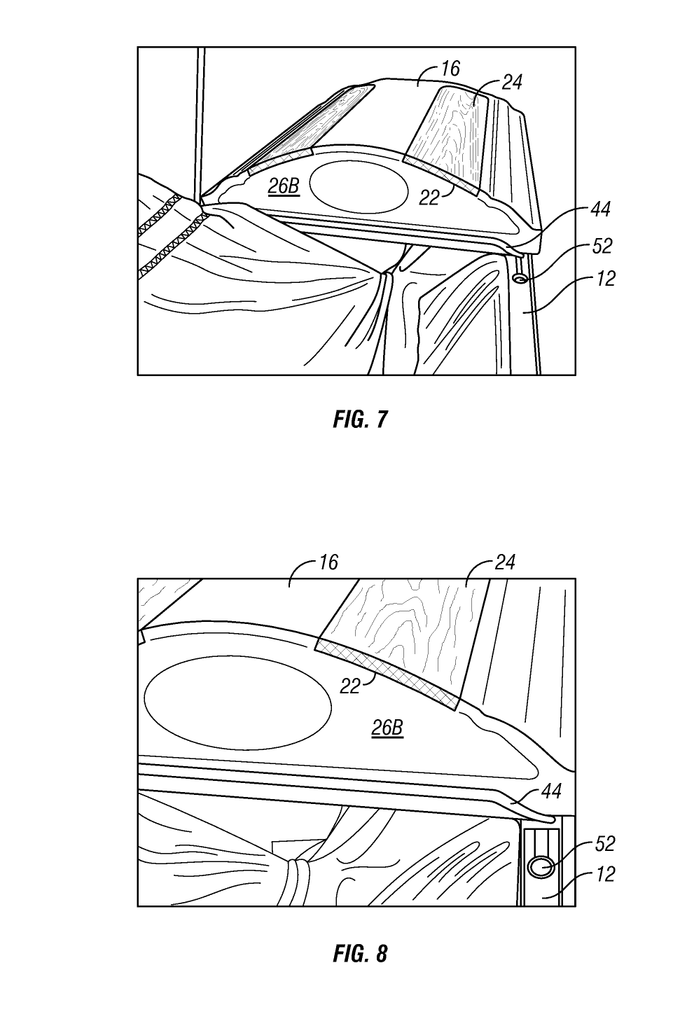

The lids 14, 16 in one embodiment are manufactured from metal sheet, e.g. 16, 18 or 20 gauge steel, which is cut and stamped to form the shape of the respective lid. For convenience herein and not by limitation, the metal sheet is referred to as steel sheet by way of example. As best seen in FIGS. 7, 8 and 13, in an embodiment a longitudinal channel 22 is formed to receive a plank 24, which is glued or screwed from underneath to be secured in the channel 22. The channel 22 thus forms a corrugation in the steel, providing structural reinforcement to the lid. In one embodiment, the channel 22 is open at inner ends 26A, 26B of the respective one of the lids 14, 16, and terminates in the lid spaced away from the outer ends 28A, 28B of the lids 14, 16. In one embodiment, the plank 24 also provides structural reinforcement. In this manner, a thinner gauge steel might be used to construct the lid than otherwise required; or stated differently, the lid is structurally more rigid than a non-inlaid lid of the same material and gauge.

To manufacture the lids 14, 16, in an embodiment, the planks 24 are cut from an appropriate material such as hardwood, a stamp press is used to shape the sheet metal into the desired shape, and then the plank 24 is secured in the channel 22 as described above. In one embodiment, the plank 24 and channel 22 are made with tight lateral tolerances to avoid the appearance of visible gaps between the edge of the plank and the edge of the channel, and with tight height or thickness tolerances so that the visible top and end surfaces of the plank 24 are flush where they meet with the respective edges of the channel 22. The exposed surfaces of the plank 24 can be finished, for example by sanding and or polishing and coating with stain, varnish, lacquer, paint or the like after assembly, to the lid 14 or 16, or in one embodiment, are finished before assembly.

In one embodiment, the channels 22 and planks 24 are provided on either side of the domed structures of the lids 14, 16. The channels 22 and planks 24 can have in one embodiment a tapered termination to match the slope of the outer ends 28A, 28B.

In an embodiment, the box 12 is provided with urn-shaped corners 30, but in other embodiments (not shown) the corners can be square or round as one skilled in the art would appreciate.

The casket 10 can in an embodiment be provided with side handles 32 and end handles 34 secured via brackets 36. In an embodiment, the brackets 36 are bolted through the sheet metal forming the side wall of the box and a respective side and end base member 38, 40. In an embodiment, the base members 38, 40 match and/or comprise the same materials as the planks 24. The base members 38, 40 in one embodiment are mounted to a smooth, continuous surface of the box 12, i.e., the base members 38, 40 project outwardly from a continuous portion of the surface of the box 12 which is not recessed or channeled. The members 38, 40 are secured in one embodiment to the box 12 between the brackets 36 and the outer surface of the box. A nut can be threadedly engaged on a bolt that extends from the bracket into the interior of the box 12. In one embodiment the handles 32, 34 can pivot or swing outwardly via the brackets 36 in a generally horizontal alignment to space the handles 32, 34 away from the box 12 to facilitate grasping the handles for carrying by pall bearers.

A gasket 42 can be provided in an embodiment around the periphery of the lids 14, 16 for sealing against an upper peripheral surface of the box 12 and/or adjacent lid 14, 16. The ends 26A, 26B of the lids 14, 16 can in an embodiment be provided with an offset or step to facilitate sealing. In one embodiment, the foot lid 16 has a lower step 44 that extends outwardly and the head lid 14 has a corresponding step recess 46 carrying the gasket 42.

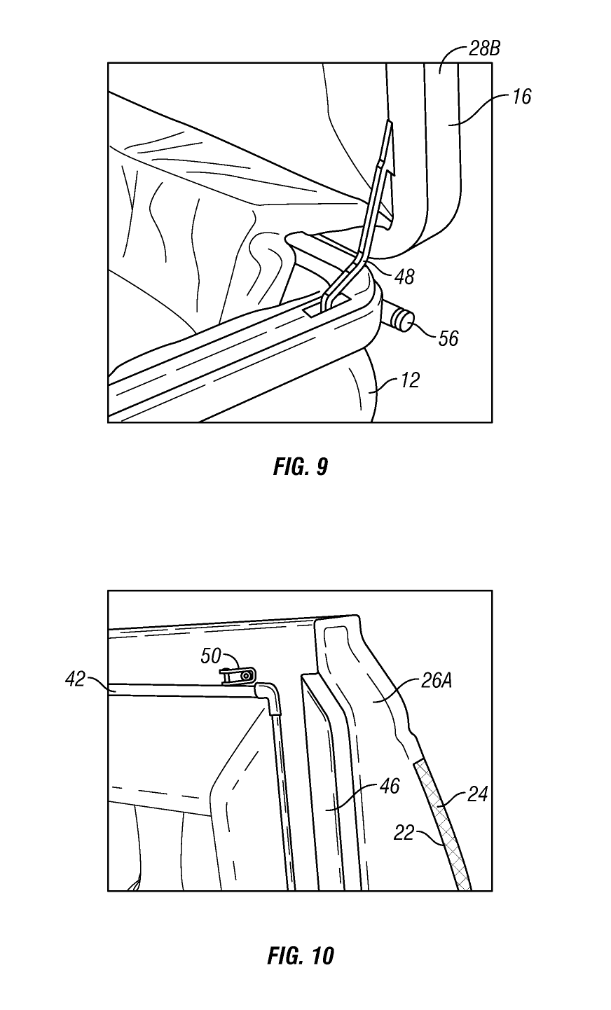

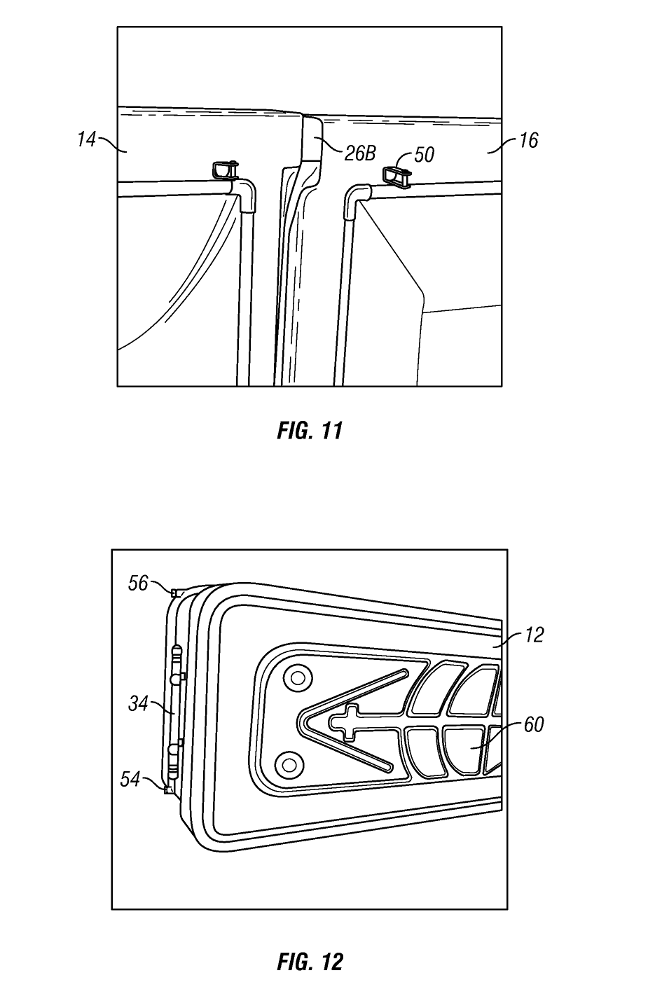

Hinges 48 are provided to secure the lids 14, 16 as desired, as best seen in the embodiment shown in FIG. 9. Locking bolts 50 can be provided in a lower edge of the lids 14, 16 as best seen in the embodiment shown in FIGS. 10-11. The bolts 50 can be received in corresponding latches 52 mounted in an upper surface at the periphery of the box 12, as best seen in the embodiment shown in FIGS. 7-8. The latches 52 can be locked in one embodiment via a locking mechanism 54 with which those skilled in the art are familiar. A storage receptacle 56 with a threaded end cap can be used to place identifying information about the contents of the casket 10.

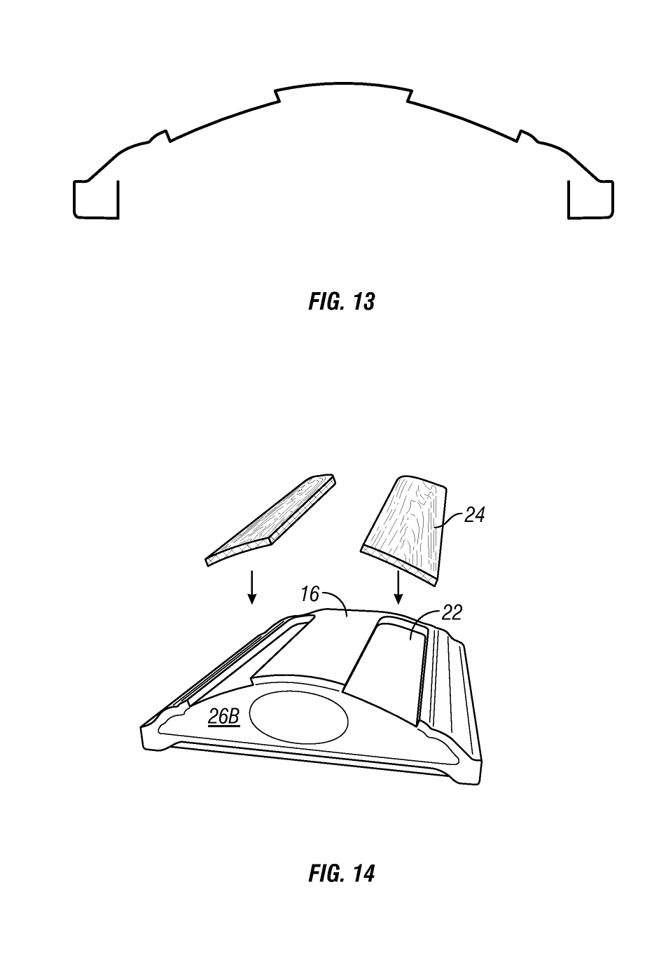

The bottom 58 of the box 12 can in an embodiment be provided with raised and/or recessed surfaces 60 to make the box 12 more rigid, as seen in FIG. 12.

The preceding description has been presented with reference to presently preferred embodiments of the invention. Persons skilled in the art and technology to which this invention pertains will appreciate that alterations and changes in the described structures and methods of operation can be practiced without meaningfully departing from the principle, and scope of this invention. Accordingly, the foregoing description should not be read as pertaining only to the precise structures described and shown in the accompanying drawings, but rather should be read as consistent with and as support for the following claims, which are to have their fullest and fairest scope.

1. A panel for use in a casket comprising sheet metal with a channel formed therein and a plank secured in the channel.

2. A casket comprising a panel according to claim 1.

3. The casket of claim 2 wherein the panel is a lid.

4. The panel of claim 1, wherein the plank comprises wood.

5. The panel of claim 1, wherein the channel forms a corrugation in the sheet metal to provide structural reinforcement.

6. The panel of claim 1, wherein visible top and end surfaces of the plank are flush at junctions with respective edges of the channel.

7. The panel of claim 1, wherein the plank has a profile matching a profile of the channel.

8. The panel of claim 1, wherein the plank is glued at opposing surfaces to the channel.

9. The panel of claim 1, wherein the plank is attached to the channel by screws.

10. A casket comprising a lid comprising steel sheet metal with a channel forming a corrugation in the sheet metal to provide structural reinforcement and a plank secured in the channel by glue or screws from underneath the plank, wherein the plank has a profile matching a profile of the channel, wherein visible top and end surfaces of the plank are flush at junctions with respective edges of the channel.

11. A method of making a casket of metal and wood comprising forming a lid of sheet metal comprising a channel formed therein and securing a plank in the channel.
